(19) United States
(12) Patent Application Publication
(10) Pub. No.: US 2018/0113231 A1
(43) Pub. Date: Apr. 26, 2018

(54) DEVICE FOR MONITORING THE RELIABILITY OF THE DETECTION UNIT OF AN APPARATUS FOR DETECTING METAL INTOXICATION OF MATERIALS PASSING THROUGH SAME

(71) Applicant: PHARMA TECHNOLOGY S.A., Nivelles (BE)

(72) Inventor: Martial Dollinger, Braine l'Alleud (BE)

(73) Assignee: PHARMA TECHNOLOGY S.A., Nivelles (BE)

(21) Appl. No.: 15/564,388

(22) PCT Filed: Apr. 7, 2015
(86) PCT No.: PCT/EP2015/000734

§ 371 Date: Oct. 4, 2017

(51) Int. Cl. G01V 3/08; G01V 13/00

(52) U.S. Cl. CPC G01V 3/08; B07C 5/344; G01V 13/00

(57) ABSTRACT

A device is suitable for checking the reliability of the detection unit of an apparatus for detecting metal contaminants in materials passing through it. The device includes a metal test piece and a transporter configured to transport said test piece in the detection device. The transport means of the device is arranged to prevent any contact between the test piece and materials passing through the detection device. In this way, no contamination exists between the test piece, the materials and the ambient environment, nor any risk of loss of the test piece among the materials.

The present invention relates to a device for checking the reliability of the detection unit of an apparatus for detecting metal poisoning of materials passing through it.

Generally, according to the prior art, to check the reliability of the detection unit of an apparatus for detecting metal poisoning of materials passing through it, whether it be food products or pharmaceutical products such as tablets or capsules, a metal test piece is introduced among the materials passing through it and it is checked whether the alarm or the means for ejecting poisoned materials from the detection unit of this device triggers as said metal test piece passes under said detection unit. It is next recovered once it has emerged from the detection device, with a view to subsequent use for the purpose of checking the reliability of the device in question. This procedure may be carried out manually by an operator, who periodically introduces a metal test piece among said materials or automatically by a means for introducing and recovering such a test piece among these materials respectively before and after passing under the detection unit of the apparatus.

This does however pose several problems. First of all, since the metal test piece is introduced among the materials the metal contamination of which is to be tested, there exists a risk that it is not recovered once the test has been carried out and that it is therefore lost in these materials once tested.

Next, it is necessary to expose the materials in question to ambient air in order to introduce the test piece among them, which, in the case of potentially toxic materials such as certain pharmaceutical products, presents a risk of contamination of this ambient air as well as of the test piece, which it is necessary to decontaminate once it is extracted from the materials being tested.

Finally, when the test piece is introduced among the materials to be tested by an operator, there exist a risk of cross contamination via the test piece between this operator and the materials in question.

The invention solves these problems by providing a device for checking the reliability of the detection unit of an apparatus for detecting metal contaminants in materials passing through it, comprising a metal test piece and a transport means for transporting said test piece in the detection device, the transport means being arranged so as to prevent any contact between said test piece and materials passing through the detection device.

The invention also provides an apparatus for detecting metal contaminants in materials, comprising a detection unit for detecting metal contaminants, an inlet and an outlet for materials, a passage space arranged between said inlet and outlet so that said materials can be exposed therein to the detection unit, the apparatus comprising a device for checking the reliability of the detection unit as described above, arranged in said passage space.

By virtue of the fact that the transport means of the reliability-checking device according to the invention is arranged so as to prevent any contact between the test piece and materials passing through the detection apparatus, no contact exists between the test piece used and, on the one hand, the materials the metal poisoning of which is to tested by the apparatus in question and, on the other hand, the operator, which solves the aforementioned problems of the reliability-checking devices according to the prior art.

The invention will now be described in more detail by means of an example of an embodiment that is not limitative of the scope of this invention, illustrated by the accompanying figures, in which:

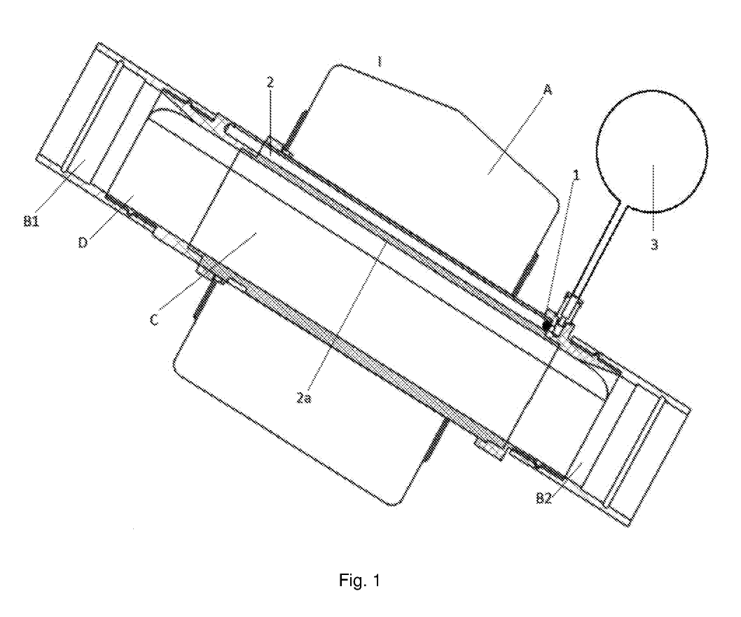

FIG. 1 shows a profile section of a device according to the invention and the detection apparatus that comprises same.

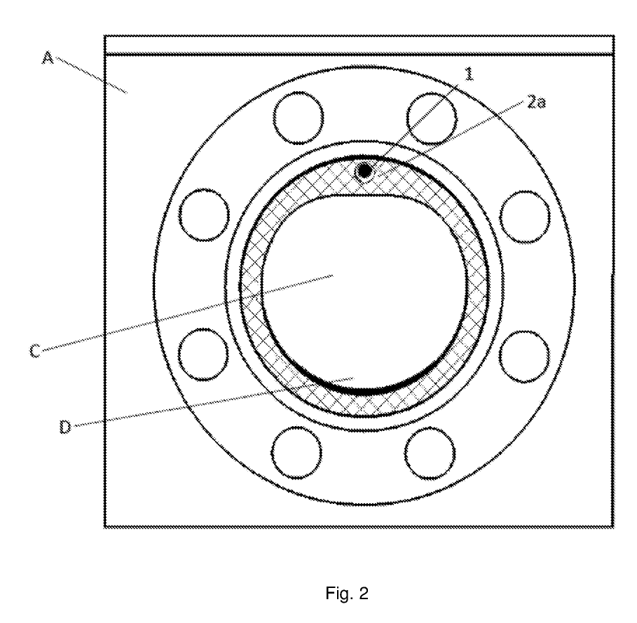

FIG. 2 shows a view in end section of a device according to the invention and of the passage provided in the detection apparatus that comprises same for the materials intended to pass through this apparatus.

Referring to the accompanying figures, a device for checking the reliability of the detection unit A of an apparatus I for detecting metal contaminants in materials passing through it is illustrated therein, comprising a metal test piece 1 and a transport means 2 for transporting said test piece in the detection device, the transport means being arranged so as to prevent any contact between said test piece and materials passing through the detection device. This transport means comprises a conduit 2a arranged so that the test piece is moved therein and a movement means 3 for moving said test piece in the conduit, this movement means being able, in an embodiment of the invention that is not illustrated, to consist of the sloping of the conduit so that the test piece can be moved therein by gravity and, in the illustrated embodiment of the invention, comprises a propulsion means for propelling the test piece in the conduit, said propulsion means comprising, in the illustrated embodiment, a compressed air source connected to the conduit and controlled either by an operator or automatically in a manner programmed at predefined intervals of time, in order, by means of the compressed air injected from a first end of the conduit, to propel the test piece in this conduit until it is stopped by a second closed end of said conduit. The test piece may in this way, in order to check the reliability of the detection apparatus, either be detected by its detection unit during the propulsion of the test piece in the conduit, or, if it is propelled therein at a speed such that it cannot be detected by said unit during the propulsion thereof but during the return fall thereof by gravity in the conduit when, as in the embodiment illustrated, the latter is inclined so that the second end thereof is higher than the first and so that the compressed air source is interrupted once the test piece has reached the second end of the conduit.

Alternatively to a compressed air source, any other means for propelling the test piece in the conduit known to persons skilled in the art may be used according to the invention, such as for example a striking pin actuated by a spring compressed and then released in order to activate the striking pin.

It should be noted that, in another embodiment of the invention that is not illustrated, a plurality of transport means and, in particular, conduits and a plurality of test pieces may be used, for example a ferrous test piece, a non-ferrous test piece and a stainless-steel test piece, so as to test the reliability of the detection unit of a detection apparatus to these various metals.

The invention illustrated also consists of an apparatus for detecting metal contaminants in materials comprising a detection unit A for detecting metal contaminants, an inlet B1 and an outlet B2 for materials, a passage space C arranged between said inlet and outlet so that some materials can be exposed therein to the detection unit, and a device for checking the reliability of the detection unit as described above in relation to the accompanying figures, the transport means of which is arranged in said passage space.

The apparatus illustrated comprises a pipe D arranged in said passage so that the materials are transported therein and the checking device is arranged outside this pipe. This embodiment of an apparatus according to the invention is particularly suited to use in the pharmaceutical industry, in which the materials to be transported through this apparatus, such as pharmaceutical tablets or capsules, must generally be isolated from the ambient atmosphere. In the case of other industries, such as the food industry for example, this requirement is not generally present and the aforementioned pipe, which isolates the materials transported through the apparatus from the ambient atmosphere, can be replaced by a conveyor belt intended to transport the materials in question, such as food products for example, through said apparatus. Likewise, in the case of sectors in which it is not essential for the test piece of the reliability-checking device according to the invention to be isolated from the operator and/or from the ambient atmosphere, the means for transporting this test piece in the detection apparatus may also, for example, comprise a conveyor belt instead of a conduit as a means for transport the test piece, and a motor intended to drive this conveyor belt as a means for moving said test piece.

1. A device for checking the reliability of the detection unit of a detection apparatus for detecting metal contaminants in materials passing therethrough, the device comprising a metal test piece and a transporter configured to transport said test piece in the detection apparatus, wherein the transporter is arranged to prevent any contact between said test piece and materials passing through the detection apparatus.

2. The device according to claim 1, wherein said transporter comprises a conduit arranged so that the test piece is moved therein and a movement device for moving said test piece in the conduit.

3. The device according to claim 2, wherein the movement device slopes the conduit so that the test piece is moved therein by gravity.

4. The device according to claim 2, wherein the movement device provides a propellant to propel the test piece in the conduit.

5. The device according to claim 4, wherein the movement device comprises a compressed air source.

6. An apparatus for detecting metal contaminants in materials, comprising a detection unit configured to detect metal contaminants, an inlet and an outlet for materials in the apparatus, a passage space for passage of said materials in the apparatus arranged between said inlet and outlet so that the materials are exposed therein to the detection unit, wherein the apparatus comprises a device configured to check the reliability of the detection unit according to any of the preceding claims, the transporter of which is arranged in said passage space.

7. The apparatus according to claim 6, further comprising a pipe disposed in said passage space and arranged so that the materials are transported therein, wherein the checking device is arranged outside said pipe.
